(19) United States
(12) Patent Application Publication
(10) Pub. No.: US 2013/0268850 A1
(43) Pub. Date: Oct. 10, 2013

(54) METHODS AND APPARATUS TO COPY AND INSERT INFORMATION

(71) Applicant: Nikos Kyprianou, Toronto (CA)

(72) Inventor: Nikos Kyprianou, Toronto (CA)

(21) Appl. No.: 13/634,838

(22) PCT Filed: Apr. 10, 2012
(86) PCT No.: PCT/CA12/50226

§ 371 Date: Sep. 13, 2012

(51) Int. Cl. G06F 17/00

(52) U.S. Cl. 715/255

(57) ABSTRACT

An example method involves creating a first association between a first placeholder identifier and a first user-specified location in a first electronic document at which subsequently selected information is to be inserted. The first placeholder identifier is stored in a data structure that stores at least one second placeholder identifier associated with at least one second user-specified location in the first electronic document or a second electronic document. In response to a user request and without accessing the first electronic document, a second association is created between the first placeholder identifier and user-selected information from a source that is separate from the first electronic document, the first placeholder identifier not being previously associated with any other user-selected information to be inserted at the first user-specified location. The user-selected information is inserted at the first user-specified location in the first electronic document based on the second association.

### FIELD OF THE DISCLOSURE

The present disclosure relates generally to electronic devices and, more particularly, to methods and apparatus to copy and insert information.

### BACKGROUND

Documents, reports, other types of electronic documents, and/or other types of electronic media are sometimes authored using information from other sources. Such electronic documents or media can be for any type of information including text, graphics, pictures, animations, video, audio, etc. When authoring such electronic documents or media, users can switch between different sources (e.g., documents or media having information to be copied) and destinations (e.g., documents or media in which information is to be inserted). In this manner, users can copy information from different sources and insert the copied information at specified locations of other electronic documents or media.

### BRIEF DESCRIPTION OF THE DRAWINGS

FIG. 1 depicts an example placeholder data structure that may be used to copy information from information sources and insert the copied information into information destinations.

FIGS. 2A-2D depict example manners of copying information from information sources using the placeholder data structure of FIG. 1 in accordance with the teachings disclosed herein.

FIG. 3 depicts an example manner of inserting copied information into information destinations using the placeholder data structure of FIGS. 1 and 2A-2D in accordance with the teachings disclosed herein.

FIG. 4 depicts an example apparatus that may be used to implement examples disclosed herein to copy information from information sources and insert the copied information into information destinations as shown in FIGS. 1, 2A-2D, and 3.

FIG. 5 depicts an example block diagram of a processor system that may be used to implement the teachings disclosed herein.

FIGS. 6A and 6B depict an example flow diagram representative of machine readable instructions that may be used to implement the apparatus of FIG. 4 to copy information from information sources and insert the copied information into information destinations as shown in FIGS. 1, 2A-2D, and 3.

### DETAILED DESCRIPTION

Although the following discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, apparatus, and articles of manufacture, persons having ordinary skill in the art will readily appreciate that the examples provided are not the only way to implement such methods, apparatus, and articles of manufacture.

It will be appreciated that, for simplicity and clarity of illustration, where considered appropriate, reference numerals may be repeated among the figures to indicate corresponding or analogous elements. In addition, numerous specific details are set forth in order to provide a thorough understanding of example embodiments disclosed herein. However, it will be understood by those of ordinary skill in the art that example embodiments disclosed herein may be practiced without these specific details. In other instances, well-known methods, procedures and components have not been described in detail so as not to obscure example embodiments disclosed herein. Also, the description is not to be considered as limiting the scope of example embodiments disclosed herein.

Example methods, apparatus, and articles of manufacture are disclosed herein in connection with electronic devices, which may be any stationary electronic device or mobile electronic device. Stationary devices may be, for examples, desktop computers, client terminals, etc. Mobile devices, also referred to as terminals, wireless terminals, mobile stations, communication stations, or user equipment (UE), may include mobile smart phones (e.g., BlackBerry® smart phones), wireless personal digital assistants (PDA), tablets (e.g., the BlackBerry® PlayBook® tablet device), laptop/notebook/netbook computers with or without wireless adapters, etc.

Example methods, apparatus, and articles of manufacture disclosed herein may be used to copy information from information sources (e.g., source documents or other media sources) and insert the copied information into information destination (e.g., destination documents or other media destinations) on electronic devices. When copying and inserting/pasting information (e.g., items, objects, data, content, or any other media), such information is copied and subsequently inserted/pasted into a new location (e.g., a destination location). In some instances, known copying and inserting/pasting techniques create unfavorable user experiences. Such unfavorable user experiences may occur, for example, when a destination location is not ready to receive copied information (e.g., inserting copied information at the end of an unfinished document), or when a user needs to switch contexts by opening one or more other applications or documents containing information to be copied and switching back to a destination document or media to insert/paste the copied information, thereby interrupting the user's flow of creativity. Also, the content to be pasted from another source may not yet be available from that other source. For example, information sources may not be available when they are on removable drives (e.g., removable universal serial bus (USB) drives), or are stored on a remote server that is only accessible at particular times or from particular network locations. When information to be copied is in another document or media source, sequential copy-and-paste operations using known techniques require at least two context switches (e.g., a first one to open the source document/media and a second one to switch back to the destination/target document at which the information is to be inserted). When information is to be copied from multiple sources and inserted/pasted into multiple destinations, the number of context switches can become relatively large (e.g., m*n context switches, where (m) represents the destination documents/media and (n) represents the source documents/media).

Examples disclosed herein are useful in improving the user experience when copying and inserting/pasting information. For example, disclosed techniques enable users to mark destination locations at which subsequently copied information is to be inserted/pasted, thus, substantially eliminating or reducing dependence on whether the subsequently copied information is available at the time when a user marks the destination location. Disclosed examples also reduce the amount of application or document context switching that a user must perform when copying information from numerous different data sources for copying to a target or destination document or media. In this manner, when content from multiple sources is destined for multiple destinations, the context switches are relatively fewer (e.g., m+n context switches). That is, examples disclosed herein enable users to: create placeholders for multiple destination locations where information is to be inserted, keep the placeholders accessible while closing corresponding destination documents or media, open source documents or media and copy information therefrom for the placeholders, and cause automatic insertion of the copied information into the destination locations of the corresponding destination documents.

In some examples, a placeholder or destination marker may be optionally deleted after its use to copy and insert/paste information, or it may optionally be preserved. When a placeholder or destination marker is preserved, the user can return to its corresponding destination location to modify the inserted/copied information (e.g., modify the font or other attributes for the text, rename a source file containing the inserted information, etc.).

When teachings disclosed herein are used in connection with mobile devices having relatively smaller screens than available on larger desktop or laptop computers, the user experience is not burdened by requiring users to keep multiple applications, documents, or media open or running in the background (e.g., in a multi-tasking environment) while navigating through different source documents or media to copy information.

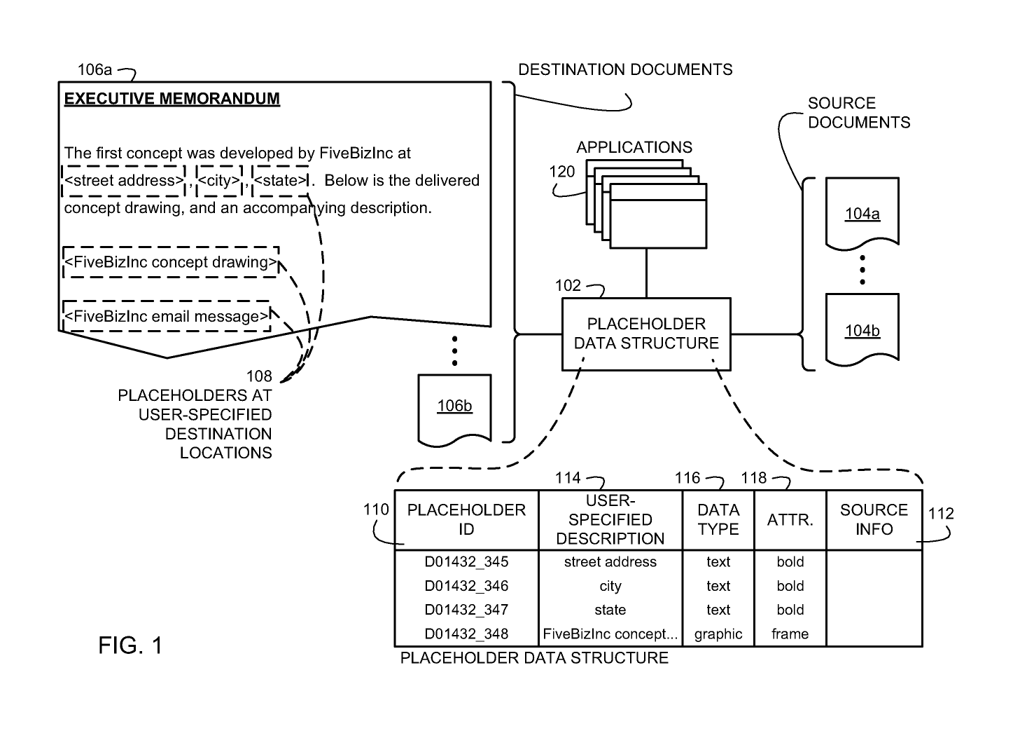

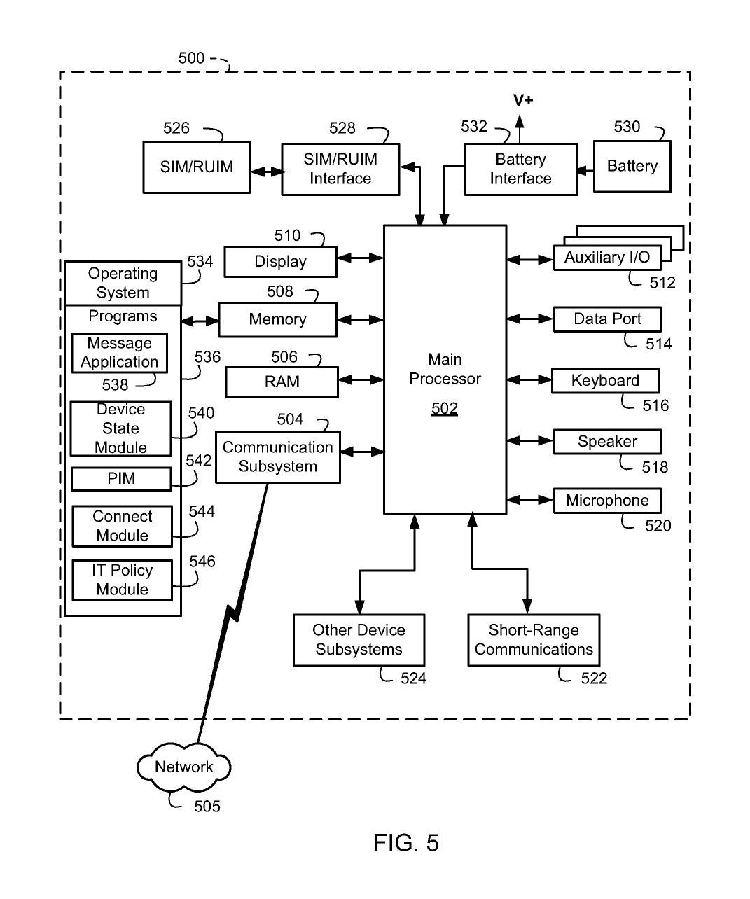

FIG. 1 depicts an example placeholder data structure 102 that may be used to copy information from one or more source documents 104a-b (e.g., information sources) and insert the copied information into one or more destination documents 106a-b (e.g., information destinations). In the illustrated example, the source documents 104a-b and the destination documents 106a-b are electronic documents, and the placeholder data structure 102, the source documents 104a-b, and the destination documents 106a-b are accessible using a computing device (e.g., the processor system of FIG. 5) and may be stored at the computing device or on another device (e.g., a removable drive, removable storage media, or a remotely accessible device) accessible by the computing device. In the illustrated example, when a user is creating, generating, editing, or writing a destination document 106a, the user identifies several placeholders at user-specified destination locations 108 at which the user desires to subsequently insert or paste respective information from one or more of the source documents 104a-b. In the illustrated example, the user-specified destination locations 108 are denoted by the placeholder labels “<street address>,” “<city>,” “<state>,” “<FiveBizInc concept drawing>,” and “<FiveBizInc email message>.”

In the illustrated example, to enable the user to subsequently insert (e.g., paste) information in the destination document 104a at the user-specified destination locations 108, the placeholder data structure 102 of the illustrated example stores placeholder identifiers 110 corresponding to respective placeholders at the user-specified destination locations 108. The placeholder data structure 102 of the illustrated example also stores source information 112 in association with respective ones of the placeholder identifiers 110 to associate respective source information 112 to be inserted at corresponding user-specified destination locations 108 identified by the placeholder identifiers 110. In this manner, the user can select the source information 112 of the illustrated example from one or more of the source documents 104a-b to be subsequently inserted (e.g., pasted) into one or more of the user-specified destination locations 108. In examples disclosed herein, source information 112 from one or more of the source documents 104a-b may be selected and stored in the placeholder data structure 102 in association with respective placeholder identifiers 110 of the destination document 106a regardless of whether the destination document 106a is open at the time of selecting the source information 112.

To copy and insert information in the illustrated example, an association is created between a placeholder identifier 110 and a corresponding user-specified destination location 108 of the destination document 106a at which subsequently selected source information 112 is to be inserted. In the illustrated example, the placeholder identifier 110 is then stored in the data structure 102 along with one or more other placeholder identifiers 110 associated with one or more other user-specified destination locations 108 of one or more of the destination documents 106a-b. In some examples, the destination document 106 is then closed before selecting corresponding source information 112. In response to a user request and without accessing the destination document 106a, a second association is made between the placeholder identifier 110 and user-selected source information 112 from a source document 104a or 104b, which is separate from the destination document 106a in the illustrated example. The user-selected source information 112 is inserted at the user-specified destination location 108 in the destination document 106a based on the second association between the placeholder identifier 110 (corresponding to the user-specified destination location 108) and the user-selected source information 112. In some examples, the user-selected source information 112 is inserted at the user-specified destination location 108 in the destination document 106a when the destination document 106a is re-opened. For example, a file open event for the destination document 106a can create a message, interrupt, or trigger to cause the user-selected source information 112 to be inserted at the user-specified destination location 108 in the destination document 106a.

In the illustrated example, the placeholder identifier 110 was not previously associated with any other user-selected source information to be inserted at the first user-specified destination location 108. That is, after the initial creation of the placeholder identifier 110, the placeholder data structure 102 is used to obtain source information 112 for inserting at a user-specified destination location 108 corresponding to the placeholder identifier 110 without needing any prior association between the source information 112 and the placeholder identifier 110. In some examples, the placeholder identifier 110 may be optionally deleted after its use to copy and insert/paste source information 112, or it may optionally be preserved. When a placeholder identifier 110 is preserved, the user can return to its corresponding user-specified destination location 108 to modify the inserted/copied information (e.g., modify the font or other attributes for the text, rename a source file containing the source information, etc.).

In the illustrated example, the placeholder data structure 102 shows only placeholders for the destination document 106a. However, the placeholder data structure 102 may additionally or alternatively store placeholders for one or more other destination documents (e.g., the destination document 106b and/or one or more other destination documents). In the illustrated example, the placeholder identifiers 110 are denoted in the format Dxxxxx_yyy, in which the portion “Dxxxxx” identifies a particular destination document (e.g., D01432 specifies the document 106a) and the portion “yyy” specifies a particular one of the user-specified destination locations 108. In some examples, the portion “Dxxxxx” may be a file path and filename. In some examples, the portion “yyy” of the placeholder identifiers 110 is encoded in corresponding ones of the user-specified destination locations 108 in the destination document 106a so that respective source information 112 from the placeholder data structure 102 can be inserted at corresponding ones of the user-specified destination locations 108 based on matching ones of the “yyy” portion. In other examples, other formats for the placeholder identifiers 110 may be used instead.

Although the source information 112 is shown in the illustrated example as stored in the placeholder data structure 102, in other examples, the placeholder data structure 102 does not store the source information 112 and instead stores source information identifiers. In such examples, the source information identifiers specify locations of source information in one or more of the destination documents 104a-b that is to be copied from the destination document(s) 104a-b and inserted at respective ones of the user-specified destination locations 108 corresponding to the placeholder identifiers 110 with which the source information identifiers are associated in the placeholder data structure 102. In some examples, storing source information identifiers pointing to source information in one or more of the source documents 104a-b is useful to reduce the amount of runtime memory or system memory used by the placeholder data structure 102. For example, when source information is large (e.g., a high-resolution image), storing the source information in the placeholder data structure 102 may use up a large quantity of memory. However, by instead storing a source information identifier pointing to a location of a source document at which the large source information (e.g., the high-resolution image) is located, the source information identifier can be used to retrieve the source information from the source document when it is time to be inserted in a destination document.

In the illustrated example, the placeholder data structure 102 also includes example user-specified descriptions 114, example data types 116, and example attributes 118. The user-specified descriptions 114 of the illustrated example enable a user to assign each of the user-specified destination locations 108 a memorable or meaningful description or label useable to remind the user of what information the user intended to insert at each of the user-specified destination locations. In the illustrated example, the user-specified descriptions 114 correspond to the labels “<street address>,” “<city>,” “<state>,” and “<FiveBizInc concept drawing>” shown in the destination document 106a at the user-specified destination locations 108.

The data types 116 of the illustrated example specify what type of information is to be inserted at each of the user-specified destination locations 108. In some examples, the data types 116 are specified by users, while in other examples, the data types 116 are specified based on the type of data (e.g., text data, graphic data, etc.), type of document (e.g., a text document, a media file, etc.), and/or the type of application associated with the destination document 104a. In the illustrated example, the data types 116 include a text type and a graphic type. However, any other data type may be specified such as a video type, an audio type, an animation type, a table type, an application-specific type (e.g., an Excel® spreadsheet), a file extension type, etc.

The attributes 118 specify any special attributes that are to be applied to the source information 112 when inserted into the destination document 104a. Such special attributes can be associated with fonts, image attributes, functional attributes (e.g., hyperlinking), or any other types of attributes. In the illustrated example, the attributes 118 specify bold font for text data types so that source information appears in bold-face type when inserted into the destination document 106a. The attributes 118 also specify a frame (or border) for the graphic data type so that a source image or graphic appears with a surrounding frame or border when inserted into the destination document 106a.

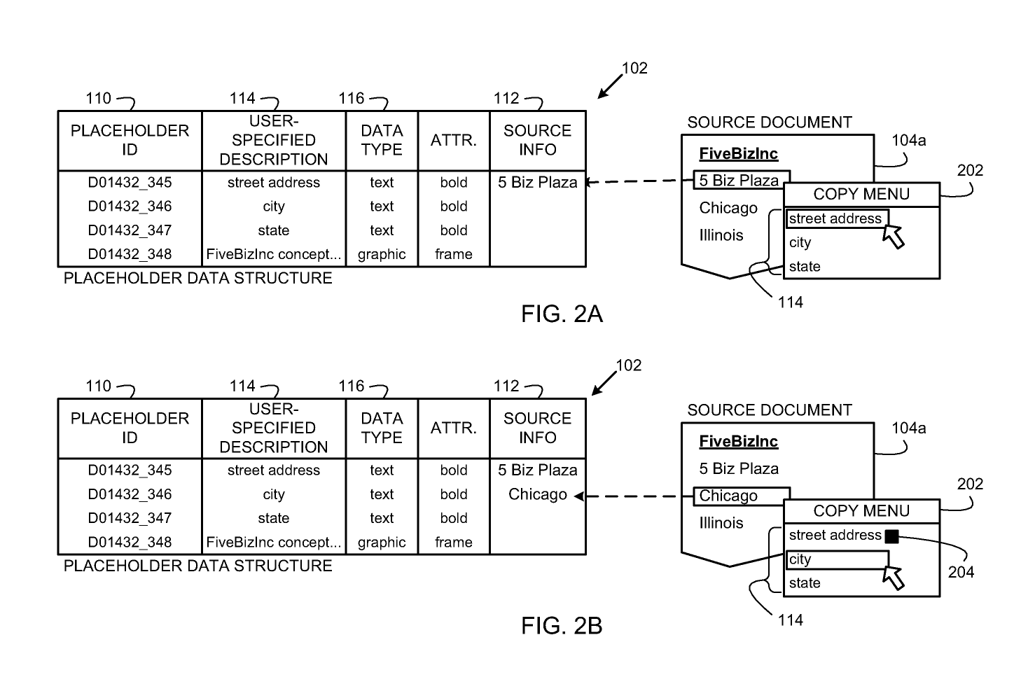

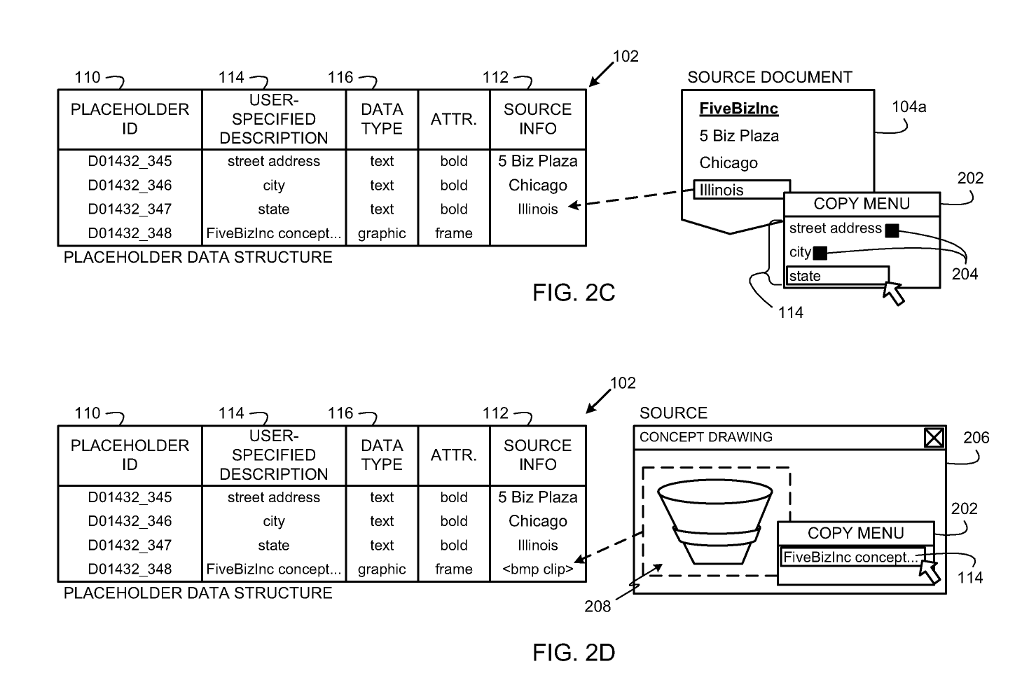

In some examples, the attributes 118 may additionally or alternatively specify conversion processes to be applied to source information 112 when inserted at the destination document(s) 106a-b to, for example, convert the source information 112 between different data types. For example, an optical character recognition (OCR) process can be performed on a selected image portraying text information so that the recognized text can be inserted at a user-specified destination location 108. Such conversions can be triggered in different manners. For example, when a user selects an image portraying text (e.g., from a portable document format (PDF) document or an image file) as source information 112 from one of the source documents 104a-b, a preliminary OCR test process can be performed to determine whether text can be recognized in the selected image. If successful, a user-interface menu (e.g., the copy menu 202 of FIGS. 2A-2D) can be presented showing placeholder identifiers 110 and/or corresponding user-specified descriptions 114 that are specified (e.g., in the data types 116) for receiving text information. Alternatively or additionally, other suitable types of format conversions may also be used (e.g., from text to an image representing the text, language translations, bit-depth or color-depth conversions for images, etc.). In some examples, format conversions are based on the data types 116 in addition to or instead of conversions being explicitly specified in the attributes 118. For example, if source information 112 is an image and the corresponding data type 116 specifies text, an image-to-text format conversion is performed on the source information 112 before inserting the source information at its user-specified destination location 108.

In the illustrated example, the source documents 104a-b and the destination documents 106a-b may contain the same or different types of information including one or more of text, graphics, pictures, animations, video, audio, etc. Although only documents 104a-b and 106a-b are shown, examples disclosed herein may additionally or alternatively be used in connection with different types of information sources including word processor documents/files, text documents/files, picture files, graphics files, video files, audio files, media streams, websites, hypertext markup language documents/files, spreadsheet files, database files, email messages, a short message service (SMS) message, an instant message, etc. In addition, the terms source and destination as used herein are relative identifiers, and may both be used to refer to the same document (or location) at different times depending on whether that document (or location) is serving as a source of information (e.g., an information source) or a destination (e.g., an information destination) in which information is to be inserted. That is, although the documents 104a-b are referred to as source documents 104a-b from which information is to be copied, and the documents 106a-b are referred to as destination documents 106a-b in which information is to be inserted, the source documents 104a-b may at some times be destination documents and the destination documents 106a-b may at some times be source documents.

In the illustrated example, the documents 104a-b and 106a-b are associated with one or more applications 120 that, for example, render, allow access to, open, save, etc. the documents 104a-b and 106a-b. Example types of the applications 120 include word processors, spreadsheet programs, database programs, email programs, image programs, media player/editor programs, web browser programs, etc. The placeholder data structure 102 of the illustrated example is generated, managed (e.g., updated), and/or persisted independent of the applications 120 of the illustrated example. In some examples, techniques disclosed herein for copying and inserting/pasting information using the placeholder data structure 102 are implemented in one or more operating system (OS) functions, processes, and/or routines that run independent of the applications 120 and that can access the documents 104a-b and 106a-b via, for example, one or more application programming interfaces (APIs). In this manner, techniques or features disclosed herein to copy and insert/paste information can be application-independent such that they can be used across the documents 104a-b and 106a-b associated with different ones of the applications 120. In other examples, the techniques disclosed herein may be implemented in an application or a program module that is separate from the applications 120 and/or that is a plug-in to, or can otherwise access, the applications 120 and access the placeholder data structure 102. In yet other examples, the techniques disclosed herein may be implemented in the applications 120, and each of the applications 120 can access the placeholder data structure 102 to create the placeholder identifiers 110, store the source information 112 from one or more of the source documents 104a-b, and/or retrieve the source information 112 from the placeholder data structure 102 to insert it in one or more of the destination documents 106a-b.

FIGS. 2A-2D depict example manners of copying information from information sources (e.g., the source documents 104a-b of FIG. 1) using the placeholder data structure 102 of FIG. 1. In the illustrated examples of FIGS. 2A-2C, the source document 104a is shown as having address information for a company called FiveBizInc. In the illustrated examples, the address information of the source document 104a is text type information. Referring to FIG. 2A, when a user selects a street address “5 Biz Plaza” in the source document 104a, an example user-interface copy menu 202 is shown to display the “street address,” “city,” and “state” user-specified descriptions 114. In the illustrated example, the copy menu 202 shows the “street address,” “city,” and “state” user-specified descriptions 114 because their specified data type 116 in the placeholder data structure 102 is text, which matches the text data type of the selected street address “5 Biz Plaza” in the source document 104a. As such, when the street address “5 Biz Plaza” is selected as shown in FIG. 2A, the “FiveBizInc concept drawing” user-specified description 114 is not shown in the copy menu 202 because its specified data type 116 in the placeholder data structure 102 is graphic, which does not match the text data type of the selected street address “5 Biz Plaza.” In the illustrated example, a user selects the “street address” user-specified description 114 in the copy menu 202 to specify the corresponding placeholder identifier 110 (and, thus, the corresponding user-specified destination location 108 of FIG. 1) with which the selected information “5 Biz Plaza” is to be associated in the placeholder data structure 102. As such, the selection of the “street address” user-specified description 114 in the copy menu 202 causes the placeholder data structure 102 to store the information “5 Biz Plaza” as source information 112 in association with the corresponding “street address” user-specified description 114 and the corresponding “D01432_345” placeholder identifier 110.

Although the illustrated examples of FIGS. 2A-2D show the example copy menu 202 as displaying the user-specified descriptions 114, in other examples, the copy menu 202 may additionally or alternatively show the placeholder identifiers 110. In some examples, the copy menu 202 shows ones of the placeholder identifiers 110 for which a user did not provide a user-specified description 114.

Turning to FIG. 2B, when a user selects a city “Chicago” in the source document 104a, the copy menu 202 displays the “street address,” “city,” and “state” user-specified descriptions 114, which match the text data type of the selected information “Chicago.” In the illustrated example, the copy menu 202 shows a filled indicator 204 next to the “street address” user-specified description 114 to indicate that the “street address” user-specified description 114 is already associated with source information 112. However, although the filled indicator 204 is shown, the “street address” user-specified description 114 is still selectable to allow the user to re-associate the “street address” user-specified description 114 with different source information. In the illustrated example of FIG. 2B, a user selects the “city” user-specified description 114 in the copy menu 202 to specify the corresponding placeholder identifier 110 (and, thus, the corresponding user-specified destination location 108 of FIG. 1) with which the selected information “Chicago” is to be associated in the placeholder data structure 102. As such, the selection of the “city” user-specified description 114 in the copy menu 202 causes the placeholder data structure 102 to store the information “Chicago” as source information 112 in association with the corresponding “city” user-specified description 114 and the corresponding “D01432_346” placeholder identifier 110.

Turning to FIG. 2C, when a user selects a state “Illinois” in the source document 104a, the copy menu 202 displays the “street address,” “city,” and “state” user-specified descriptions 114, which match the text data type of the selected information “Illinois.” The copy menu 202 of FIG. 2C shows the filled indicators 204 next to the “street address” and “city” user-specified descriptions 114. In the illustrated example of FIG. 2B, a user-selection of the “state” user-specified description 114 in the copy menu 202 causes the placeholder data structure 102 to store the information “Illinois” as source information 112 in association with the corresponding “state” user-specified description 114 and the corresponding “D01432_347” placeholder identifier 110.

Turning to FIG. 2D, the information source is an image file 206 having a drawing 208 to be inserted into the destination document 106a of FIG. 1. In the illustrated example of FIG. 2D, a user-selection of the drawing 208 in the information source 206 causes the copy menu 202 to display the “FiveBizInc concept drawing” user-specified description 114 based on the selected drawing 208 being a graphic and the data type of the “FiveBizInc concept drawing” user-specified description 114 being a graphic data type. As such, a user-selection of the “FiveBizInc concept drawing” user-specified description 114 in the copy menu 202 causes the placeholder data structure 102 to store the drawing 208 as source information 112 in association with the corresponding “FiveBizInc concept drawing” user-specified description 114 and the corresponding “D01432_348” placeholder identifier 110. In the illustrated example, the placeholder data structure 102 stores the drawing 208 as a bitmap (bmp) clip. Alternatively, the placeholder data structure 102 may instead store a pointer (e.g., a file path, file name, and selection coordinates defining the selected boundaries surrounding the drawing 208 in the information source 206) to the drawing 208 so that the drawing 208 can be retrieved from the information source 206 when it is to be inserted into the destination document 106a.

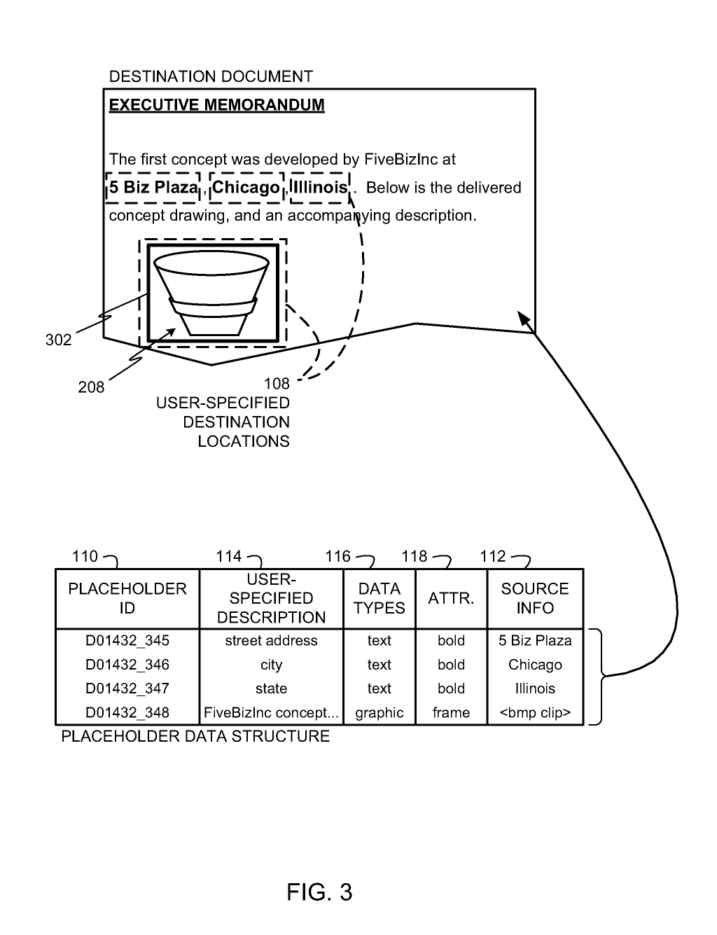

FIG. 3 depicts an example manner of inserting copied source information 112 into the destination document 106a using the placeholder data structure 102 of FIGS. 1 and 2A-2D. In the illustrated example, when a user re-opens the destination document 106a, an open event causes the source information 112 from the placeholder data structure 102 to be inserted at corresponding ones of the user-specified destination locations 108 as shown in FIG. 3. In the illustrated example, the attributes 118 specified in the placeholder data structure 102 are applied to the source information 112 when inserted in the destination document 106a. For example, the inserted text is shown in bold type face and a frame or border 302 is placed around the inserted drawing 208.

In some examples, the inserting or pasting of the source information 112 into the destination document 106a is done automatically upon detecting a file open event corresponding to the destination document 106a being re-opened. In other examples, the source information 112 is inserted at designated destinations at any other suitable times (e.g., not only when a user opens a destination document 106a-b). In some examples, when the destination document 106a is re-opened (or at any other suitable time), a user-interface message or menu is presented to allow a user to confirm whether the source information 112 should be inserted in the destination document 106a. In some examples, a user may pre-set a configuration setting to specify whether source information 112 should be automatically inserted into destination documents 106a-b or whether the user should be prompted each time to confirm when the source information 112 should be inserted at designated destinations.

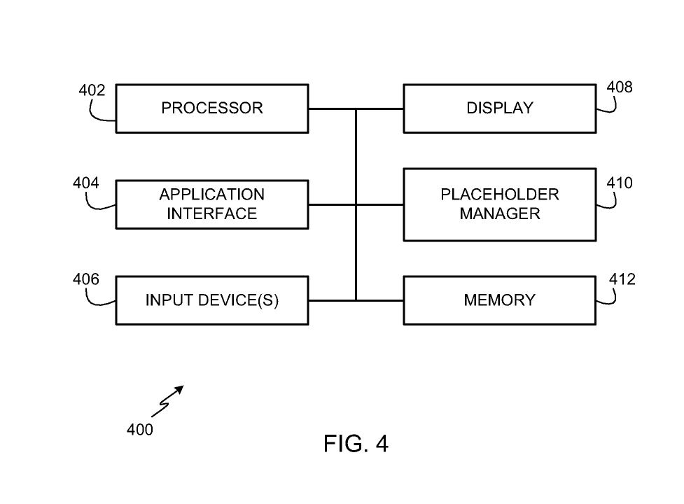

FIG. 4 depicts an example apparatus 400 that may be used to implement examples disclosed herein to copy information (e.g., the source information 112 of FIGS. 1 and 2A-2D) from source documents (e.g., the source documents 104a-b and 206 of FIGS. 1 and 2A-2D) and insert the copied information into destination documents (e.g., the destination documents 106a-b of FIGS. 1 and 3) as shown in FIGS. 1, 2A-2D, and 3. In the illustrated example of FIG. 11, the apparatus 400 is provided with example subsystems including: a processor (or controller) 402, an example application interface 404, one or more example input device(s) 406, an example display 408, an example placeholder manager 410, and an example memory 412. The subsystems 402-412 may be implemented using any desired combination of hardware, firmware, and/or software. For example, one or more integrated circuits, discrete semiconductor components, and/or passive electronic components may be used. Thus, for example, the subsystems 402-412, or parts thereof, could be implemented using one or more circuit(s), programmable processor(s), application specific integrated circuit(s) (ASIC(s)), programmable logic device(s) (PLD(s)), field programmable logic device(s) (FPLD(s)), etc. The subsystems 402-412, or parts thereof, may be implemented using instructions, code, and/or other software and/or firmware, etc. stored on a machine accessible medium or computer readable medium (e.g., the memory 412) and executable by, for example, a processor (e.g., the example processor 402). When any of the apparatus or system claims of this patent is read to cover a purely software implementation, at least one of the subsystems 402-412 is hereby expressly defined to include a tangible medium such as a solid state memory, a magnetic memory, a digital versatile disk (DVD), a compact disk (CD), a BluRay disk, etc. Further still, the example apparatus 400 of FIG. 4 may include one or more elements, methods and/or devices in addition to, or instead of, those illustrated in FIG. 4, and/or may include more than one of any or all of the illustrated elements, methods and devices.

Turning in detail to FIG. 4, the apparatus 400 of the illustrated example is provided with the example processor 402 to control and/or manage operations of computing devices implementing examples disclosed herein. In the illustrated example, the processor 402 runs the applications 120 to open, modify, and close the documents 104a-b and 106a-b of FIG. 1. In addition, the processor 402 makes decisions and facilitates/arbitrates information exchanges between elements of the apparatus 400.

In the illustrated example, the apparatus 400 is provided with the application interface 404 to access the electronic documents 104a-b and 106a-b, the image file 206 (FIG. 2D), and/or the applications 120 of FIG. 1. In some examples, the application interface is an API that allows operating system (OS) level processes or functions to access information in the electronic documents 104a-b and 106a-b, the image file 206, and/or the applications 120. In some examples, the application interface 404 is used in a software module that is configured to operate as a plug-in or add-on feature to the applications 120 to access the electronic documents 104a-b and 106a-b and/or the image file 206.

In the illustrated example, the apparatus 400 is provided with the one or more input device(s) 406 to receive inputs that are input by a user using one or more input devices (e.g., one or more of a touch screen, a mouse pointer, a touch pad, buttons, a keyboard, a microphone, etc.). In the illustrated example, the input device(s) 406 may be implemented using any suitable types of input device interfaces (e.g., one or more of a mouse interface, a touch pad interface, a button interface, a keyboard interface, a voice interface, etc.).

In the illustrated example, the apparatus 400 is provided with the display 408 (e.g., a display of the mobile device 500 of FIG. 5) that is configured to provide a graphical user interface and display electronic documents or other media (e.g., the electronic documents 104a-b and 106a-b and/or the image file 206). The display 408 may be implemented using any suitable type of display technology such as liquid crystal displays (LCDs), e-paper displays, cathode ray tube (CRT) displays, light-emitting diode (LED) displays, etc.

In the illustrated example, the apparatus 400 is provided with the placeholder manager 410 to manage (e.g., generate and update) the placeholder data structure 102 and manage the copying of information (e.g., the source information 112 of FIGS. 1, 2A-2D, and 3) from information sources (e.g., the source documents 104a-b of FIGS. 1 and 2A-2C and the image file 206 of FIG. 2D) and the inserting of the copied information into information destinations (e.g., the destination documents 106a-b of FIGS. 1 and 3). The placeholder manager 410 of the illustrated example works with the application interface 404 to communicate with the applications 120 and access information sources and information destinations. In some examples, the placeholder manager 410 is implemented using one or more OS level functions, processes, and/or routines that run independent of the applications 120. In other examples, the placeholder manager 410 is implemented in an application, a program module, a library, or a framework that is separate from the applications 120 and/or that is a plug-in to or can otherwise access the applications 120. In yet other examples, one or more placeholder managers substantially similar or identical to the placeholder manager 410 are implemented in the applications 120.

In the illustrated example, to store data and/or machine-readable or computer-readable instructions, the apparatus 400 is provided with the memory 412. The memory 412 may be a mass storage memory magnetic or optical memory, a non-volatile integrated circuit memory, or a volatile memory. That is, the memory 412 may be any tangible medium such as a solid state memory, a magnetic memory, a DVD, a CD, a BluRay disk, etc.

FIG. 5 depicts a block diagram of an example implementation of a processor system that may be used to implement a mobile device 500. In the illustrated example, the mobile device 500 is used to implement the apparatus 400 of FIG. 4. In the illustrated example, the mobile device 500 is a two-way communication device with advanced data communication capabilities including the capability to communicate with other wireless-enabled devices or computer systems through a network of transceiver stations. The mobile device 500 may also have the capability to allow voice communication. Depending on the functionality provided by the mobile device 500, it may be referred to as a data messaging device, a two-way pager, a cellular telephone with data messaging capabilities, a smart phone, a wireless Internet appliance, a tablet device, or a data communication device (with or without telephony capabilities). Although FIG. 5 depicts an example implementation of the mobile device 500 as having a number of components, in some example implementations, some of the components shown in FIG. 5 may be omitted and/or may be externally connected to the mobile device 500 (e.g., via interface port(s) and/or via wireless interface(s)). To aid the reader in understanding the structure of the mobile device 500 and how it communicates with other devices and host systems, FIG. 5 will now be described in detail.

Referring to FIG. 5, the mobile device 500 includes a number of components such as a main processor 502 (e.g., similar or identical to the processor 402 of FIG. 4 and/or used to implement the processor 402) that controls the overall operation of the mobile device 500. Communication functions, including data and voice communications, are performed through a communication subsystem 504. The communication subsystem 504 receives messages from and sends messages to a wireless network 505. In the illustrated example of the mobile device 500, the communication subsystem 504 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). In some examples, the communication subsystem 504 is configured in accordance with the 3rd Generation Partnership Project (3GPP) Long Term Evolution (LTE), which is the next evolutionary phase of UMTS and CDMA2000 networks to a common air interface standard. New standards are still being defined, but it is believed that they will have similarities to the network behavior described herein, and it will also be understood by persons skilled in the art that the example implementations described herein are intended to use any other suitable standards that are developed in the future. The wireless link connecting the communication subsystem 504 with the wireless network 505 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 505 associated with the mobile device 500 is a GSM/GPRS wireless network in one exemplary implementation, other wireless networks may also be associated with the mobile device 500 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include WiFi 802.11, MOBITEX® and DATATAC® network communication systems. Examples of other voice-centric data networks include Personal Communication Systems (PCS) networks like GSM and Time Division Multiple Access (TDMA) systems.

The main processor 502 also interacts with additional subsystems such as a Random Access Memory (RAM) 1206, a persistent memory 508 (e.g., a non-volatile memory), a display 510, an auxiliary input/output (I/O) subsystem 512, a data port 514, a keyboard 516, a speaker 518, a microphone 520, short-range communications 522, and other device subsystems 524.

Some of the subsystems of the mobile device 500 perform communication-related functions, whereas other subsystems may provide “resident” or on-device functions. By way of example, the display 510 and the keyboard 516 may be used for both communication-related functions, such as entering a text message for transmission over the network 505, and device-resident functions such as a calculator or task list. In the illustrated example, the display 510 is used to implement the display 408 of FIG. 4, and the keyboard 516 and/or auxiliary input/output (I/O) subsystem 512 is used to implement the input device(s) 406 of FIG. 4.

The mobile device 500 can send and receive communication signals over the wireless network 505 after required network registration or activation procedures have been completed. Network access is associated with a subscriber or user of the mobile device 500. To identify a subscriber, the mobile device 500 requires a SIM/RUIM card 526 (i.e. Subscriber Identity Module or a Removable User Identity Module) to be inserted into a SIM/RUIM interface 528 in order to communicate with a network. The SIM card or RUIM 526 is one type of a conventional “smart card” that can be used to identify a subscriber of the mobile device 500 and to personalize the mobile device 500, among other things. Without the SIM card 526, the mobile device 500 is not fully operational for communication with the wireless network 505. By inserting the SIM card/RUIM 526 into the SIM/RUIM interface 528, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 526 includes a processor and memory for storing information. Once the SIM card/RUIM 526 is inserted into the SIM/RUIM interface 528, it is coupled to the main processor 502. In order to identify the subscriber, the SIM card/RUIM 526 can include some user parameters such as an International Mobile Subscriber Identity (IMSI). An advantage of using the SIM card/RUIM 526 is that a subscriber is not necessarily bound by any single physical mobile device. The SIM card/RUIM 526 may store additional subscriber information for a mobile device as well, including datebook (or calendar) information and recent call information. Alternatively, user identification information can also be programmed into the persistent memory 508.

The mobile device 500 is a battery-powered device and includes a battery interface 532 for receiving one or more rechargeable batteries 530. In at least some embodiments, the battery 530 can be a smart battery with an embedded microprocessor. The battery interface 532 is coupled to a regulator (not shown), which assists the battery 530 in providing power V+ to the mobile device 500. Although current technology makes use of a battery, future technologies such as micro fuel cells may provide the power to the mobile device 500.

The mobile device 500 also includes an operating system 534 and software components 536 to 546 (e.g., some of which are one or more of the applications 120 of FIG. 1) which are described in more detail below. The operating system 534 and the software components 536 to 546 that are executed by the main processor 502 are typically stored in a persistent store such as the persistent memory 508, which may alternatively be a read-only memory (ROM) or similar storage element (not shown). Those skilled in the art will appreciate that portions of the operating system 534 and the software components 536 to 546, such as specific device applications, or parts thereof, may be temporarily loaded into a volatile store such as the RAM 506. Other software components can also be included, as is well known to those skilled in the art.

The subset of software applications 536 that control basic device operations, including data and voice communication applications, will normally be installed on the mobile device 500 during its manufacture. Other software applications include a message application 538 that can be any suitable software program that allows a user of the mobile device 500 to send and receive electronic messages. Various alternatives exist for the message application 538 as is well known to those skilled in the art. Messages that have been sent or received by the user are typically stored in the persistent memory 508 of the mobile device 500 or some other suitable storage element in the mobile device 500. In at least some embodiments, some of the sent and received messages may be stored remotely from the mobile device 500 such as in a data store of an associated host system that the mobile device 500 communicates with.

The software applications can further include a device state module 540, a Personal Information Manager (PIM) 542, and other suitable modules (not shown). The device state module 540 provides persistence (i.e., the device state module 540 ensures that important device data is stored in persistent memory, such as the persistent memory 508, so that the data is not lost when the mobile device 500 is turned off or loses power).

The PIM 542 includes functionality for organizing and managing data items of interest to the user, such as, but not limited to, e-mail, contacts, calendar events, voice mails, appointments, and task items. A PIM application has the ability to send and receive data items via the wireless network 505. PIM data items may be seamlessly integrated, synchronized, and updated via the wireless network 505 with the mobile device subscriber's corresponding data items stored and/or associated with a host computer system. This functionality creates a mirrored host computer on the mobile device 500 with respect to such items. This can be particularly advantageous when the host computer system is the mobile device subscriber's office computer system.

The mobile device 500 also includes a connect module 544, and an IT policy module 546. The connect module 544 implements the communication protocols that are required for the mobile device 500 to communicate with the wireless infrastructure and any host system, such as an enterprise system, with which the mobile device 500 is authorized to interface.

Other types of software applications can also be installed on the mobile device 500. These software applications can be third party applications, which are added after the manufacture of the mobile device 500. Examples of third party applications include games, calculators, utilities, productivity applications, etc.

The additional applications can be loaded onto the mobile device 500 through at least one of the wireless network 505, the auxiliary I/O subsystem 512, the data port 514, the short-range communications subsystem 522, or any other suitable device subsystem 524. This flexibility in application installation increases the functionality of the mobile device 500 and may provide enhanced on-device functions, communication-related functions, or both. For example, secure communication applications may enable electronic commerce functions and other such financial transactions to be performed using the mobile device 500.

The data port 514 enables a subscriber to set preferences through an external device or software application and extends the capabilities of the mobile device 500 by providing for information or software downloads to the mobile device 500 other than through a wireless communication network. The alternate download path may, for example, be used to load an encryption key onto the mobile device 500 through a direct and thus reliable and trusted connection to provide secure device communication.

The data port 514 can be any suitable port that enables data communication between the mobile device 500 and another computing device. The data port 514 can be a serial or a parallel port. In some instances, the data port 514 can be a USB port that includes data lines for data transfer and a supply line that can provide a charging current to charge the battery 530 of the mobile device 500.

The short-range communications subsystem 522 provides for communication between the mobile device 500 and different systems or devices, without the use of the wireless network 505. For example, the subsystem 522 may include an infrared device and associated circuits and components for short-range communication. Examples of short-range communication standards include standards developed by the Infrared Data Association (IrDA), a Bluetooth® communication standard, and the 802.11 family of standards developed by IEEE.

In use, a received signal such as a text message, an e-mail message, web page download, media content, etc. will be processed by the communication subsystem 504 and input to the main processor 502. The main processor 502 will then process the received signal for output to the display 510 or alternatively to the auxiliary I/O subsystem 512. A subscriber may also compose data items, such as e-mail messages or the destination documents 106a-b of FIG. 1, for example, using the keyboard 516 in conjunction with the display 510 and, in some examples, the auxiliary I/O subsystem 512. The auxiliary subsystem 512 may include input devices such as: a touch screen, mouse, track ball, infrared fingerprint detector, or a roller wheel with dynamic button pressing capability. The keyboard 516 is preferably an alphanumeric keyboard and/or telephone-type keypad. However, other types of keyboards may also be used. A composed item may be transmitted over the wireless network 505 through the communication subsystem 504.

For voice communications, the overall operation of the mobile device 500 is substantially similar, except that the received signals are output to the speaker 518, and signals for transmission are generated by the microphone 520. Alternative voice or audio I/O subsystems, such as a voice message recording subsystem, can also be implemented on the mobile device 500. Although voice or audio signal output is accomplished primarily through the speaker 518, the display 510 can also be used to provide additional information such as the identity of a calling party, duration of a voice call, or other voice call related information.

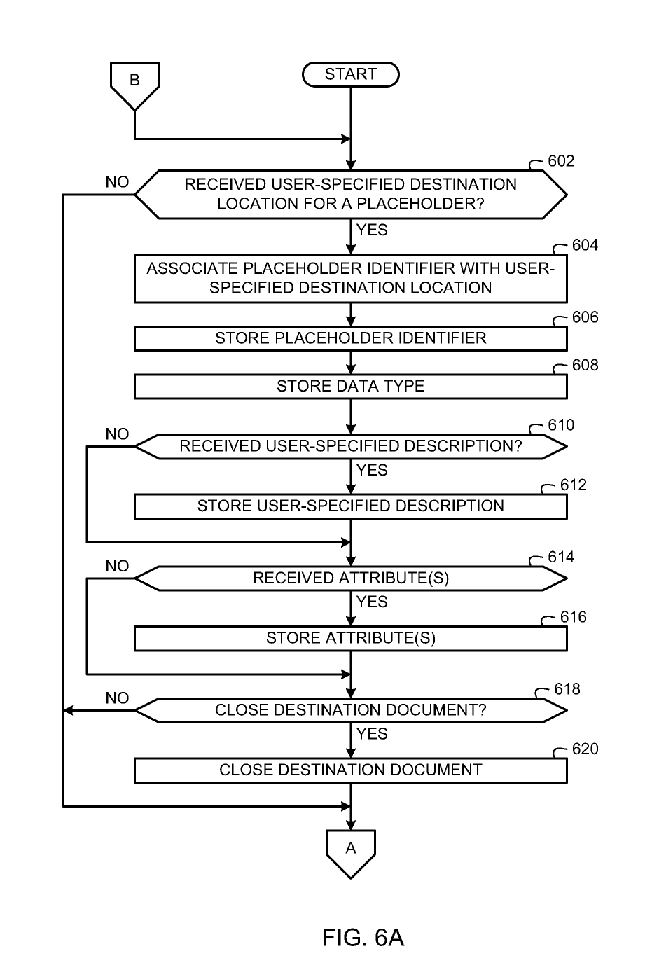

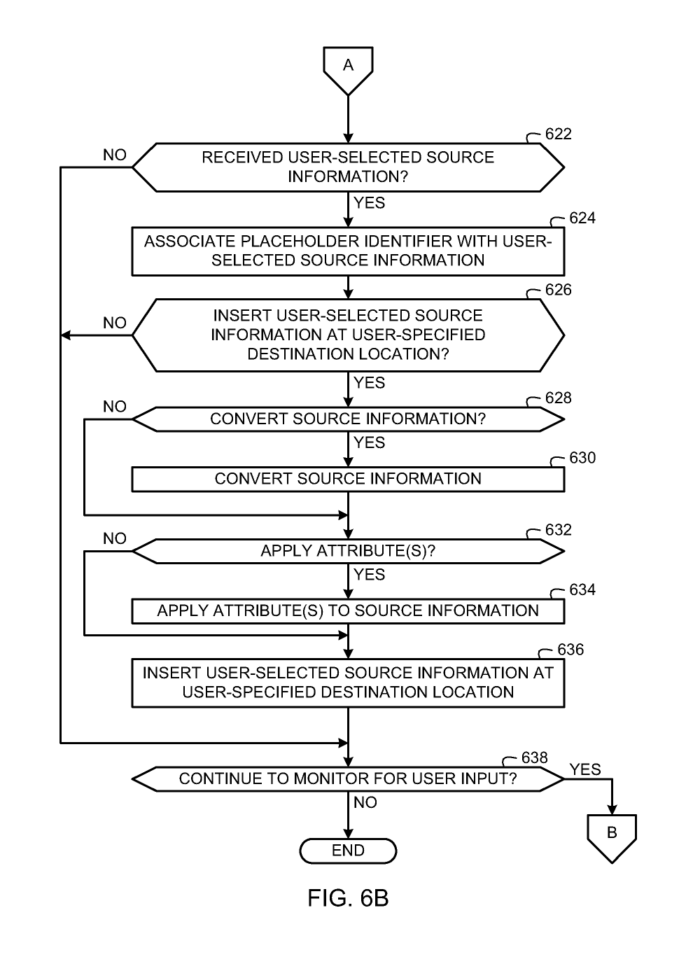

FIGS. 6A and 6B depict an example flow diagram representative of machine readable instructions that may be used to implement the apparatus 400 of FIG. 4 to copy information (e.g., the source information 112 of FIGS. 1 and 2A-2D) from source documents (e.g., the source documents 104a-b and 206 of FIGS. 1 and 2A-2D) and insert the copied information into destination documents (e.g., the destination documents 106a-b of FIGS. 1 and 3) as shown in FIGS. 1, 2A-2D, and 3. The example method of FIGS. 6A and 6B may be performed using one or more processors, controllers, and/or any other suitable processing devices (e.g., the example processor 402 of FIG. 4 and/or the example processor 502 of FIG. 5). For example, the example method of FIGS. 6A and 6B may be implemented using coded instructions (e.g., computer readable instructions) stored on one or more tangible computer readable media such as flash memory, read-only memory (ROM), and/or random-access memory (RAM), a CD-ROM, a floppy disk, a hard drive, a DVD, a BluRay disk, or a memory associated with the processor 402 and/or 502. In some examples, the method in its entirety and/or parts thereof could alternatively be executed by a device other than the processor 402 and/or 502 and/or embodied in firmware or dedicated hardware. As used herein, the term tangible computer readable medium is expressly defined to include any type of computer readable storage and to exclude propagating signals. Additionally or alternatively, the example method of FIGS. 6A and 6B may be implemented using coded instructions (e.g., computer readable instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information). As used herein, the term tangible computer readable medium is expressly defined to include any type of computer readable medium and to exclude propagating signals.

Additionally or alternatively, the example method of FIGS. 6A and 6B may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example method of FIGS. 6A and 6B may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example method of FIGS. 6A and 6B may be implemented manually or as any combination(s) of any of the foregoing techniques, for example, any combination of firmware, software, discrete logic and/or hardware. Further, although the example method of FIGS. 6A and 6B is described with reference to the flow diagram of FIGS. 6A and 6B, other methods of implementing the method of FIGS. 6A and 6B may be employed. For example, the order of execution of the blocks may be changed, and/or some of the blocks described may be changed, eliminated, sub-divided, or combined. Additionally, any or all of the example method of FIGS. 6A and 6B may be performed sequentially and/or in parallel by, for example, separate processing threads, processors, devices, discrete logic, circuits, etc. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

In some examples, instructions to perform the example method of FIGS. 6A and 6B are implemented in one or more operating system functions. In this manner, the example method of FIGS. 6A and 6B is application-independent such that it can be used across different applications that interface with the operating system function(s). In other examples, instructions to perform the example method of FIGS. 6A and 6B are implemented in applications, add-on modules, and/or plug-in modules that can be added to, installed in, or can otherwise access different applications (e.g., the applications 120 of FIG. 1). In yet other examples, instructions to perform the example method of FIGS. 6A and 6B are implemented directly in applications (e.g., the applications 120 of FIG. 1).

Now turning in detail to FIG. 6A, initially, the processor 402 (FIG. 4) determines whether a user-specified destination location for a placeholder 108 (FIG. 1) has been received (block 602). For example, the processor 402 may receive an indication of a user input via one or more of the input device(s) 406 (FIG. 4) that specifies a placeholder 108 in the destination document 106a of FIG. 1. If a user-specified destination location for a placeholder 108 has not been received, control advances to block 622 of FIG. 6B. Otherwise, if the processor 402 determines at block 602 that a placeholder at a user-specified destination location 108 is received, the placeholder manager 410 (FIG. 4) associates a placeholder identifier 110 (FIG. 1) with the user-specified destination location 108 (block 604). In the illustrated example, to associate the placeholder identifier 110 with the user-specified destination location 108, the placeholder manager 410 causes the application interface 404 to encode the placeholder identifier 110 or a portion thereof (e.g., the “yyy” portion of the “Dxxxxx_yyy” placeholder format described above in connection with FIG. 1) in the destination document 106a at the user-specified destination location 108 to identify the location within the destination document 106a at which subsequently selected source information 112 associated with the placeholder identifier 110 should be inserted. The placeholder manager 410 stores the placeholder identifier 110 in the placeholder data structure 102 (FIGS. 1, 2A-2D, and 3) (block 606). In the illustrated example, the placeholder manager 410 also stores a data type 116 (FIGS. 1, 2A-2D, and 3) in the placeholder data structure 102 in association with the placeholder identifier 110 (block 608).

In the illustrated example, the processor 402 determines whether a user-specified description 114 (FIGS. 1, 2A-2D, and 3) has been received (block 610) for the placeholder at the user-specified destination location 108 received at block 602. For example, the user-specified description 114 can be received via, for example, one or more of the input device(s) 406. If a user-specified description 114 has not been received, control advances to block 614. Otherwise, if the processor 402 determines at block 610 that a user-specified description 114 has been received, the placeholder manager 410 stores the user-specified description 114 in the placeholder data structure 102 in association with the placeholder identifier 110 (block 612).

In the illustrated example, the processor 402 determines whether any special attribute(s) 118 (FIGS. 1, 2A-2D, and 3) has/have been received (block 614) for the placeholder at the user-specified destination location 108 received at block 602. For example, the attribute(s) 118 can be received via, for example, one or more of the input device(s) 406. If one or more attribute(s) 118 has/have not been received, control advances to block 618. Otherwise, if the processor 402 determines at block 614 that one or more attribute(s) 118 has/have been received, the placeholder manager 410 stores the attribute(s) 118 in the placeholder data structure 102 in association with the placeholder identifier 110 (block 616).

In the illustrated example, the processor 402 determines whether a user has selected to close the destination document 106a (block 618). As discussed above, a user may select source information 112 (FIGS. 1, 2A-2D, and 3) to insert or paste at a placeholder at the user-specified destination location 108 when the destination document 106a is closed or at any other time (e.g., when the destination document 106a is open in the background or foreground of a user workspace). If the processor 402 determines at block 618 that the destination document 106a should not be closed, control advances to block 622 of FIG. 6B. Otherwise, if the processor 402 determines at block 618 that a user has selected to close the destination document 106a, the processor 402 closes the destination document 106a (block 620).

Turning to FIG. 6B, the processor 402 determines whether user-selected source information 112 has been received (block 622). In some examples, a user selects source information 112 as described above in connection with FIGS. 2A-2D. At block 622, the application interface 404 may receive an indication of user-selected source information 112 from an application (e.g., one of the applications 120 of FIG. 1) hosting a source document or other information source file (e.g., the source documents 104a-b of FIGS. 1 and 2A-2C and/or the image file 206 of FIG. 2D). If the processor 402 determines at block 622 that user-selected source information 112 has not been received, control advances to block 638. Otherwise, if the processor 402 determines at block 622 that user-selected source information 112 has been received, the placeholder manager 410 associates the placeholder identifier 110 with the user-selected source information 112 (block 624). In the illustrated example, the placeholder manager 410 associates the placeholder identifier 110 with the user-selected source information 112 without accessing the destination document 106a (e.g., when the destination document 106a is closed, or when it is open). In some examples, to associate the placeholder identifier 110 with the user-selected source information 112, the placeholder manager 410 retrieves the source information 112 from the information source via the application interface 404 and stores the source information 112 in the placeholder data structure 102 in association with the respective placeholder identifier 110. In other examples, the placeholder manager 410 retrieves location information via the application interface 404 indicative of the location of the source information 112 within a source document or file (e.g., the source documents 104a-b and/or the image file 206), and stores a pointer (e.g., a file path, file name, and coordinates or character positions defining the boundaries of the source information 112) to the source information 112 in the placeholder data structure 102.

The processor 402 determines whether the user-selected source information 112 should be inserted at the placeholder at the user-specified destination location 108 (block 626). In some examples, the processor 402 determines that the source information 112 should be inserted at the user-specified destination location 108 in response to detecting a re-opening of the destination document 106a. In such examples, the application interface 404 generates a file open event or notification when the destination document 106a is opening, which causes the processor 402 to determine that the source information 112 should be inserted at the user-specified destination location 108. In other examples, the processor 402 causes a message prompt to be displayed requiring user confirmation before proceeding with inserting the source information 112 at the user-specified destination location 108. In some examples, such user confirmation message prompt can be displayed in response to detecting that the destination document 106a is being opened, or at any other suitable time.

If the processor 402 determines at block 626 that the user-selected source information 112 should not be inserted at the placeholder at the user-specified destination location 108, control advances to block 638. Otherwise, the processor 402 determines whether the source information 112 should be converted when inserted in the user-specified destination location 108 (block 628). For example, if the source information 112 is in a graphic format and the destination data type 116 is text (or an attribute 118 specifies a conversion to text), the processor 402 determines that it should convert the graphic into text (e.g., via an OCR process). Alternatively or additionally, other suitable types of conversions may also be applied (e.g., from text to an image representing the text, language translations, bit-depth or color-depth conversions for images, etc.).

If the processor 402 determines that the source information 112 should not be converted, control advances to block 632. Otherwise, the processor 402 and/or the placeholder manager 410 convert(s) the source information 112 (block 630) as specified in the placeholder data structure 102. The processor 402 then determines whether there are any attributes 118 noted in the placeholder data structure 102 that should be applied to the source information 112 (block 632). If the processor 402 determines that there are not any attributes 118 noted in the placeholder data structure 102 to apply to the source information 112, control advances to block 636. Otherwise, the processor 402 and/or the placeholder manager 410 applies one or more noted attribute(s) 118 to the source information 112 (block 634).

The processor 402, the application interface 404, and/or the placeholder manager 410 insert(s) the user-selected source information 112 at the placeholder at the user-specified destination location 108 (block 636). For example, the user-selected source information 112 may be inserted at the user-specified destination location 108 as described above in connection with FIG. 3. The processor 402 determines whether to continue to monitor for user input (block 638). For example, further user input may be additional placeholders at user-specified destination locations 108 and/or additional source information 112. If the processor 402 determines that it should continue to monitor for user input (e.g., the processor 402 has not been shutdown or put in a low-power standby state), control returns to block 602 of FIG. 6A. Otherwise, the example process of FIGS. 6A and 6B ends.

Although certain methods, apparatus, and articles of manufacture have been described herein, the scope of coverage of this disclosure is not limited thereto. To the contrary, this disclosure covers all methods, apparatus, and articles of manufacture fairly falling within the scope of the claims either literally or under the doctrine of equivalents.

What is claimed is:

1. A method to insert information in electronic documents, comprising:
creating a first association between a first placeholder identifier and a first user-specified location in a first electronic document at which subsequently selected information is to be inserted;
storing the first placeholder identifier in a data structure that stores at least one second placeholder identifier associated with at least one second user-specified location in the first electronic document or a second electronic document;
in response to a user request and without accessing the first electronic document, creating a second association between the first placeholder identifier and user-selected information from a source that is separate from the first electronic document, the first placeholder identifier not being previously associated with any other user-selected information to be inserted at the first user-specified location; and
inserting the user-selected information at the first user-specified location in the first electronic document based on the second association.

2. A method as defined in claim 1, further comprising storing user-specified descriptions in the data structure in association with corresponding ones of the first and second placeholder identifiers, the user-specified descriptions descriptive of information to be inserted at corresponding ones of the first and second user-specified locations.

3. A method as defined in claim 2, further comprising displaying at least the first and second placeholder identifiers or corresponding ones of the user-specified descriptions independent of an application used to render the first electronic document.

4. A method as defined in claim 1, further comprising generating and updating the data structure independent of an application that renders the first electronic document.

5. A method as defined in claim 1, further comprising generating and updating the data structure using an operating system process.

6. A method as defined in claim 1, further comprising selectively specifying the at least one second placeholder identifier to insert second user-selected information at the at least one second user-specified location corresponding to the at least one second placeholder identifier.

7. A method as defined in claim 1, wherein the creating of the second association of the first placeholder identifier with the user-selected information is performed while the first electronic document is closed, and the inserting of the user-selected information at the first user-specified location in the first electronic document is performed when the first electronic document is re-opened.

8. A method as defined in claim 1, wherein the first electronic document is one of a word processor document, a hypertext markup language document, a spreadsheet, or a text document.

9. A method as defined in claim 1, further comprising converting the user-selected information from a first format to a second format before inserting the user-selected information at the first user-specified location in the first electronic document.

10. A method as defined in claim 9, wherein the first format is a graphic and the second format is text.

11. A method to copy and insert information, comprising:
storing a placeholder identifier in association with a pointer in a data structure, the placeholder identifier associated with a location in a destination file, the pointer indicative of user-selected information in a source that is separate from the destination file, and the data structure separate from the destination file, the source, and at least one application hosting the destination file and the source;
converting the user-selected source information from a first format in which the user-selected source information appears in the source to a second format; and
inserting the user-selected source information at the location in the destination file based on the second format.

12. A method as defined in claim 11, wherein the first format is a graphic and the second format is text, and the converting of the user-selected source information from the first format to the second format comprising performing an optical recognition process.

13. A method as defined in claim 11, wherein the inserting of the user-selected source information is performed based on detecting a file open event corresponding to opening of the destination file.

14. A method as defined in claim 13, wherein the converting of the user-selected source information is performed based on the detecting of the file open event.

15. A method as defined in claim 11, further comprising a user-specified description in the data structure in association with the placeholder identifier.

16. A method as defined in claim 11, wherein the source is one of a word processor document, a web page, a media file, or an email message.

17. An apparatus to insert information in electronic documents, comprising:
a placeholder data structure to store a first placeholder identifier associated with a first user-specified location in a first electronic document, and at least one second placeholder identifier associated with at least one second user-specified location in the first electronic document or a second electronic document;
a placeholder manager to:
creating a first association between the first placeholder identifier and the first user-specified location at which subsequently selected information is to be inserted, and
in response to a user request and without accessing the first electronic document, create a second association between the first placeholder identifier and user-selected information from a source that is separate from the first electronic document, the first placeholder identifier not being previously associated with any other user-selected information to be inserted at the first user-specified location; and
an application interface to insert the user-selected information at the first user-specified location in the first electronic document based on the second association.

18. An apparatus as defined in claim 17, wherein the data structure is further to store user-specified descriptions in association with corresponding ones of the first and second placeholder identifiers, the user-specified descriptions indicative of types of information to be inserted at corresponding ones of the first and second user-specified locations.

19. An apparatus as defined in claim 18, further comprising a display to display at least the first and second placeholder identifiers or corresponding ones of the user-specified descriptions independent of an application used to render the first electronic document.

20. An apparatus as defined in claim 17, wherein the placeholder manager is to generate and update the data structure independent of an application that renders the first electronic document.

21. An apparatus as defined in claim 17, wherein the placeholder manager is to generate and update the data structure using an operating system process.

22. An apparatus as defined in claim 17, further comprising an input device to receive a user selection indicative of the at least one second placeholder identifier to insert second user-selected information at the at least one second user-specified location corresponding to the at least one second placeholder identifier.

23. An apparatus as defined in claim 17, wherein the creating of the second association of the first placeholder identifier with the user-selected information is performed while the first electronic document is closed, and the inserting of the user-selected information at the first user-specified location in the first electronic document is performed when the first electronic document is re-opened.

24. An apparatus as defined in claim 17, wherein the first electronic document is one of a word processor document, a hypertext markup language document, a spreadsheet, or a text document.

25. An apparatus as defined in claim 17, further comprising a processor to convert the user-selected information from a first format to a second format before inserting the user-selected information at the first user-specified location in the first electronic document.

26. An apparatus as defined in claim 25, wherein the first format is a graphic and the second format is text.
